(19) United States
(12) Patent Application Publication
(10) Pub. No.: US 2025/0353221 A1
(43) Pub. Date: Nov. 20, 2025

(54) MULTI-CAVITY HANDLE PLATEN CONVEYOR - FORMING APPLICATION

(71) Applicant: Preco, LLC, Lenexa, KS (US)

(72) Inventors: Paul J. Johnson, Lenexa, KS (US); Lowell L. Teague, Lenexa, KS (US)

(21) Appl. No.: 19/208,014

(22) Filed: May 14, 2025

Related U.S. Application Data
(60) Provisional application No. 63/647,163, filed on May 14, 2024.

(51) Int. Cl. B29C 43/08; B29C 43/18; B29C 43/32; B29C 43/46; B29L 31/46

(52) U.S. Cl. CPC B29C 43/085; B29C 43/18; B29C 2043/185; B29C 2043/189; B29C 2043/3277; B29C 2043/464; B29L 2031/463

(57) ABSTRACT

A system and method for pressforming handles. The system broadly includes a carriage, a conveyor, a plate train, and a roller press. The conveyor assembly is mounted on the carriage and includes first and second sprockets rotatably supported on the carriage and a roller chain linking the sprockets together. The plate train is conveyably engaged with the roller chain and includes several plates. Each plate includes a flat portion and a number of pockets spaced from each other. The roller press is configured to rotate relative to the carriage and engage a web of shapable material opposite the plates of the plate train. The roller press includes several protrusions annularly and longitudinally spaced apart from each other and configured to press the shapable material into the pockets of the plates thereby forming bands of the handles.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/647,163; titled “MULTI-CAVITY HANDLE PLATEN CONVEYOR-FORMING APPLICATION”; and filed May 14, 2024. The Provisional Application is hereby incorporated by reference, in its entirety, into the current patent application.

### BACKGROUND

Disposable handles are often formed on cat litter boxes, soap detergent boxes, sand boxes, paper bags, and other containers. Forming such handles significantly increases production time and is often the limiting factor on container production rates.

### SUMMARY

Embodiments of the present invention solve the above problems and other problems by providing a handle pressforming system that provides increased production speed and output. Specifically, the handle pressforming system combines conveyor mechanics with roller mechanics to increase the number of handles that can be in production at a given time.

An embodiment of the invention is a handle pressforming system broadly comprising a carriage, a conveyor, a plate train, and a roller press. The conveyor assembly is mounted on the carriage and includes first and second sprockets rotatably supported on the carriage and a roller chain linking the sprockets together. The plate train is conveyably engaged with the roller chain and includes a number of plates each including a flat portion and a number of pockets spaced from each other. The roller press is configured to rotate relative to the carriage and engage a web of shapable material opposite the plates of the plate train. The roller press includes a number of protrusions annularly and longitudinally spaced apart from each other and configured to press the shapable material into the pockets of the plates thereby forming bands of the handles.

Another embodiment is a method of pressforming handles. The method broadly comprises a step of conveying a plate of a plate train to a pressforming position near a roller press. The method further includes a step of feeding a web of shapable material between the plate and the roller press. The method further includes a step of shifting the roller press so that a number of protrusions of the roller press extend into a plurality of pockets of the plate thereby forming bands of the handles from the shapable material.

Another embodiment is a handle pressforming system broadly comprising a carriage, a conveyor assembly, a plate train, a roller press, a sensor, an idler roller, and a compression roller. The conveyor assembly is mounted on the carriage and includes first and second shafts rotatably supported on the carriage, first and second sprockets attached to the shafts, and a roller chain linking the first and second sprockets together. The plate train is conveyably engaged with the roller chain and includes a number of plates pivotably connected to each other. Each plate includes a flat portion and a number of pockets spaced apart from each other. The roller press is configured to engage a web of shapable material opposite the plates of the plate train. The roller press includes a third shaft rotatably supported on the carriage and a number of discs attached to the third shaft. Each disc includes a number of protrusions annularly spaced apart from each other via intermedia portions. The protrusions are configured to press the shapable material into the pockets of the plates. The sensor is positioned near the plate train for ensuring timely application of adhesive to the web of shapable material relative to the pockets. The idler roller is configured to initiate bonding between the shapable material and a substrate material via the adhesive. The compression roller is spaced from the idler roller and configured to compress the shapable material and the substrate material to increase bond strength therebetween.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a perspective view of a handle pressforming system in accordance with an embodiment of the invention;

FIG. 2 is a perspective view of a plurality of handles formed by the handle pressforming system of FIG. 1;

FIG. 3 is an enlarged perspective view of certain components of the handle pressforming system of FIG. 1;

FIG. 4 is a perspective view of a plate of the handle pressforming system of FIG. 1; and

FIG. 5 is a flow diagram depicting certain steps of a method of pressforming handles in accordance with another embodiment of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION

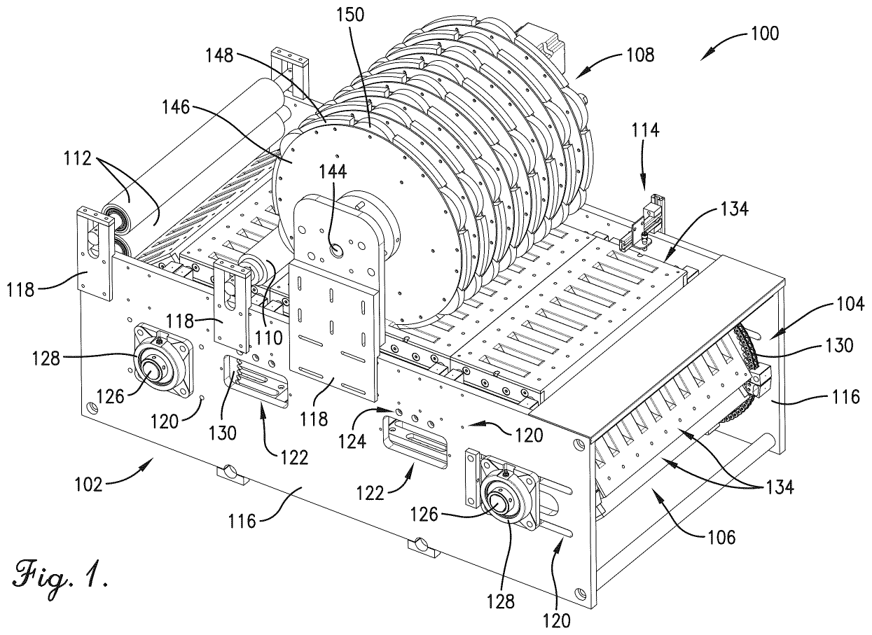

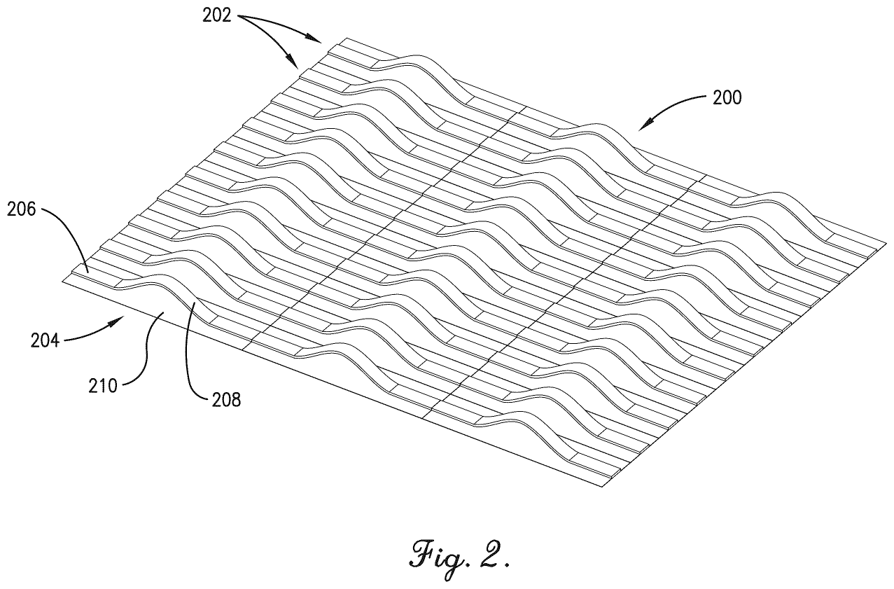

Turning now to the FIGS. 1-4, a handle pressforming system (hereinafter system 100) constructed in accordance with an embodiment of the invention is illustrated. The system 100 broadly comprises a carriage 102, a conveyor assembly 104, a plate train 106, a roller press 108, an idler roller 110, compression rollers 112, and a sensor 114. The system 100 may be used to form handles 200 via a web of shapable material 202 and a web of substrate material 204 (FIG. 2). The shapable material 202 may be paper, plastic, or any other suitable material. The substrate material 204 may also be paper, plastic, or any other suitable material and may the same, a similar, or a different material compared to the shapable material 202. Portions of the substrate material 204 may be bonded to portions of the shapable material 202 via adhesive, although other joining means such as stitching, stapling, interlacing, or the like may be used.

The carriage 102 supports the conveyor assembly 104, the plate train 106, the roller press 108, the idler roller 110, and the compression rollers 112. The carriage 102 may have two opposing, spaced apart panels 116 attached together by rods, or may be a box frame or any other suitable structure. Each panel 116 may include a plurality of mounting holes 120, a plurality of lift openings 122, and a plurality of vacuum holes 124. Components of the system 100 may be supported on the carriage 102 via brackets 118 attached to the panels 116.

The mounting holes 120 may be configured to receive fasteners for securing the conveyor assembly 104, the roller press 108, the idler roller 110, the compression rollers 112, and the sensor 114 to the panels 116 of the carriage 102. Some of the mounting holes 120 may be slots for adjustably mounting certain components to the carriage 102.

The lift openings 122 may be used to lift and maneuver the system 100 in a manufacturing space. To that end, the lift openings 122 may be shaped and positioned for receiving lift tines, hooks, lift cables, and the like. The lift openings 122 may also be used to access various components of the conveyor assembly 104, the plate train 106, or vacuum lines.

The vacuum holes 124 may be configured to receive vacuum lines for supplying vacuums to vacuum apertures of the plates 134. In one embodiment, the vacuum holes 124 may be positioned above the lift openings 122.

The conveyor assembly 104 conveyably drives the plate train 106 past the roller press 108 and the idler roller 110. The conveyor assembly 104 may include at least two shafts 126, at least two sets of opposing bearings 128, at least two sets of opposing sprockets 130, and at least two opposing roller chains 132.

The shafts 126 may extend between the opposing panels 116 of the carriage 102 and may be rotatably supported thereon via the bearings 128. Each shaft 126 in turn may support a set of opposing sprockets 130.

The bearings 128 may be mounted in or on the panels 116 of the carriage 102 via the mounting holes 120 and rotatably support the shafts 126. A spacing of the bearings 128 may be adjustable for ease of assembly of the conveyor assembly 104 or for providing sufficient tautness of the roller chains 132.

The sprockets 130 may be supported on the shafts 126 and may be configured to guide the roller chains 132 in a loop. In other embodiments, sheaves, pulleys, or the like may be used with belts instead of chains.

The roller chains 132 may be looped over the sprockets 130 for conveyably driving the plates 134 of the plate train 106. In other embodiments, belts may be used with sheaves, pulleys, or the like.

The plate train 106 may be a plurality of plates 134 conveyably engaged by the conveyor assembly 104. The plate train 106 may include between approximately ten and fourteen plates 134. In one embodiment, the plate train 106 may include twelve plates.

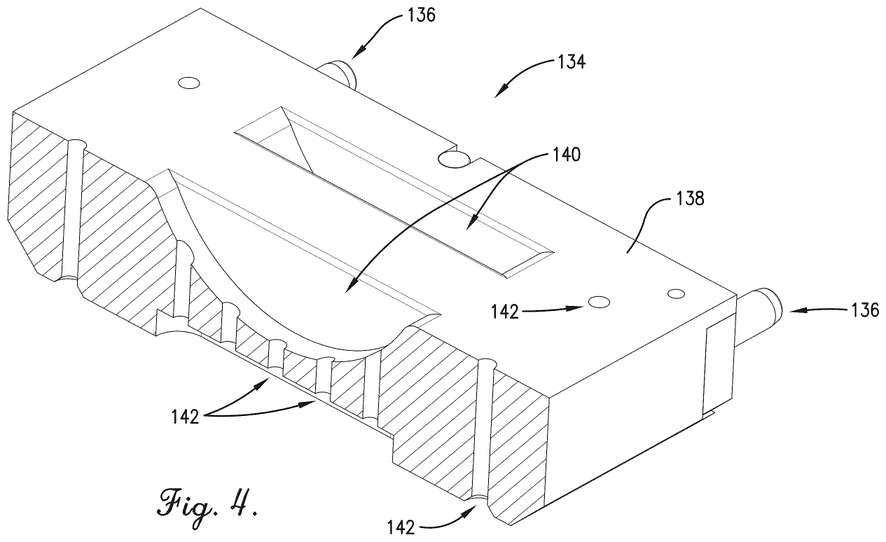

The plates 134 may be pivotably connected to each other for following the chains 132. Each plate 134 may be substantially similar so only one plate 134 will be described in detail. As best seen in FIG. 4, the plate 134 may include a plurality of struts 136, a flat portion 138, a plurality of pockets 140, and a plurality of vacuum apertures 142.

The struts 136 may be side protrusions configured to be engaged by the chains 132 for driving the plates 134. The struts 136 may include grooves or other features for retaining the struts 136 in engagement with the chains 132.

The flat portion 138 may encircle the pockets 140. In other words, the flat portion 138 may separate the pockets 140 and may extend in front and aft of the pockets 140. The flat portion 138 may be configured to support portions of the shapable material 202 (hereinafter bases 206) that should remain flat for bonding with the substrate material 204.

The pockets 140 may be recesses extending into the plate 134 for receiving portions of the shapable material 202 intended to create bands 208 of the handles 200. The pockets 140 may be generally concave and may have a curved shape. In one embodiment, the pockets 140 have a constant radius. In another embodiment, the pockets 140 have a varying radius thereby forming flatter portions and more curved portions. The plate 134 may have any number of pockets such as between eight and twelve pockets. In one embodiment, the plate 134 may include ten pockets.

The vacuum apertures 142 extend through the plate 134 for providing a vacuum thereto. Some of the vacuum apertures 142 may extend from the flat portion 138, while other vacuum apertures 142 extend from the pockets 140. The vacuum apertures 142 extending from the flat portion may be configured to retain the shapable material 202 against the flat portion 138. In contrast, the vacuum apertures 142 extending from the pockets 140 may be configured to retain the shapable material in the pockets 140 in the shape of the bands 208. To that end, the vacuum apertures 142 may be configured to at least temporarily align with vacuum lines when the plate 134 is in a pressforming position relative to the roller press 108 for creating a vacuum in the vacuum apertures 142.

Turning again to FIG. 1, the roller press 108 may be rotationally supported on the carriage 102 and may include a shaft 144, a plurality of discs 146. The roller press 108 may be configured to rotate to pressform the shapable material 202 into the pockets 140 of a plate 134 in the pressforming position.

The shaft 144 may extend between and may be supported on the panels 116 of the carriage 102. In one embodiment, the shaft 144 is supported on bearings similar to the bearings 128 described above.

The discs 146 may be attached to the shaft 144 to rotate therewith. Each disc 146 may include intermediate portions 148 and a plurality of protrusions 150. The roller press 108 may include any number of discs such as between eight and twelve discs. In one embodiment, the roller press 108 includes ten discs 146 (matching the ten pockets 140 of each plate 134). The discs 146 may be spaced apart from each other to align with the pockets 140. The discs 146 may also be spaced apart from each other. At least one of the spaces between the discs 146 and the intermediate portions 148 may allow for adhesive on the web of shapable material to pass under the roller press 108 without being disturbed.

The intermediate portions 148 may extend between protrusions 150 and may be configured to align with the flat portions 138 of the plates 134 fore and aft of the pockets 140. To that end, the intermediate portions 148 may have a constant radius from a rotational axis of the roller press 108. In other embodiments, the intermediate portions 148 may be flat or recessed (and thereby configured to form a substantial gap between the discs 146 and the plates 134).

The protrusions 150 may extend radially outward from the rotational axis of the roller press 108 for extending into the pockets 140 of a plate 134 when the plate 134 is in the pressforming position. To that end, the protrusions 150 may be annularly spaced apart from each other (e.g., via the intermediate portions 148). Furthermore, the protrusions 150 may have a shape complementary to a shape of the pockets 140 for pressing the shapable material 202 into the pockets 140. For example, the protrusions 150 may have a constant radius or a varying radius. Each protrusion 150 may also be in longitudinal alignment with a protrusion from each of the other discs 146.

The roller press 108 has been described as including discrete disc components. However, in other embodiments, the roller press 108 may be a single substantially cylindrical body with protrusions extending from the substantially cylindrical body.

The idler roller 110 may be rotatably mounted on the carriage 102 near the roller press 108 and above the conveyor assembly 104 and the plate train 106. The idler roller 110 may be configured to guide or press the web of substrate material 204 against the web of shapable material 202 (and more specifically the base 206) after the band 208 has been formed. The idler roller 110 may be adjustable for setting a desired tension of the substrate material 204 or a desired pressure of the substrate material 204 against the base 206.

The compression rollers 112 may be rotatably mounted on the carriage 102 and spaced from the idler roller 110. The compression rollers 112 may be configured to pass the substrate material 204 and the shapable material 202 between them to apply compression thereto. To that end, the compression rollers 112 may be adjustable for setting a desired compression.

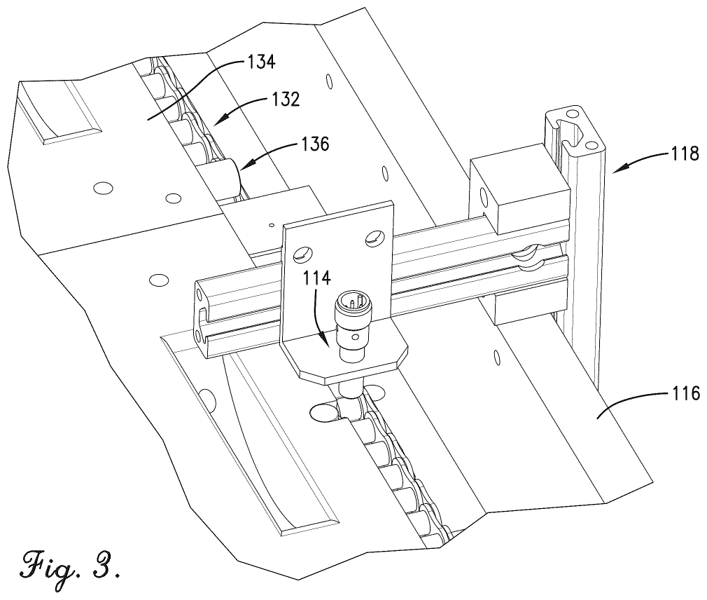

With reference to FIGS. 1 and 3, the sensor 114 may be mounted on the carriage 102 above the conveyor assembly 104 and plate train 106 and configured to sense a position of the plates 134 as they pass the sensor 114. The sensor 114 may be a proximity sensor, a Hall Effect sensor, an optical sensor, or the like. In the case of a Hall Effect sensor, the plates 134 may include a target configured to induce a signal in the sensor 114. In other cases, other targets such as optical targets, fiducials, or the like may be used.

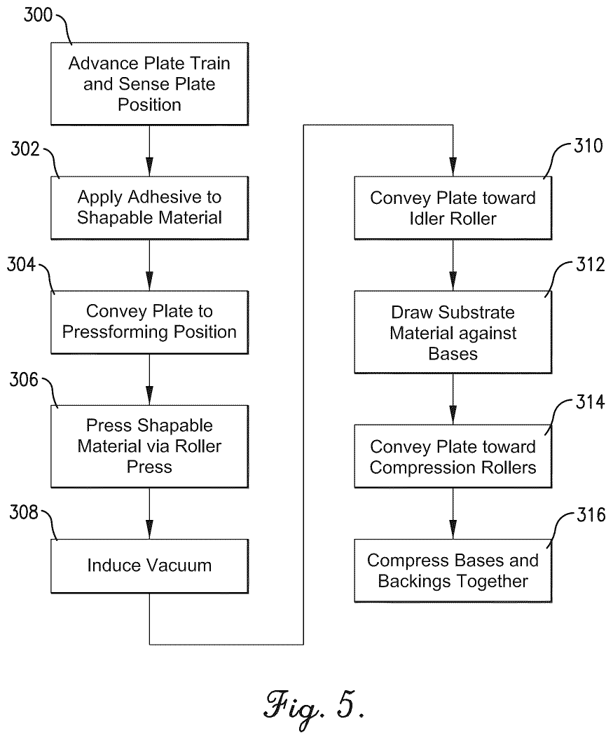

Turning to FIG. 5 and with reference to FIGS. 1-4, use of the system 100 will now be described in more detail. First, the plate train 106 may be advanced so that a plate 134 of the plate train 106 is conveyed to a sensing position, as shown in block 300. The sensor 114 may detect that the plate 134 is at the sensing position, which may indicate that adhesive should be applied to the web of shapable material 202.

An adhesive may then be applied to the portions of the web of shapable material 202, as shown in block 302. The adhesive may be applied to the web of shapable material when the plate 134 is at the sensing position or after the plate 134 has been conveyed to a later position (such as near an adhesive applicator).

The web of shapable material 202 may also be cut at this time to delineate portions of the shapable material forming different handles. Alternatively, the web of shapable material 202 and/or the substrate material 204 may be precut. As yet another alternative, the roller press 108 may cut the web of shapable material simultaneously with the pressforming step described below. As yet a further alternative, cutting may be performed after pressforming to cut the substrate material 204 and/or the shapable material 202 to delineate different handles 200.

The plate train 106 may then be advanced so that the plate 134 is conveyed to a pressforming position near the roller press 108, as shown in block 304. Simultaneously or sequentially, the roller press 108 may be shifted so that some of the protrusions 150 press portions of the web of shapable material 202 into the pockets 140 of the plate 134, as shown in block 306. In one embodiment, the roller press 108 is rotated about the shaft 144. In other embodiments, the roller press 108 is translated downward (with our without rotation) toward the plate 134. In one embodiment, advancement of the plate train 106 (and hence conveyance of the plate 134) and shifting of the roller press 108 may be achieved continuously with smooth motion.

A vacuum may also be created via the vacuum apertures 142, as shown in block 308. This serves two purposes. The vacuum corresponding to the vacuum apertures 142 extending from the flat portion 138 of the plate 134 retains the bases 206 formed from the web of shapable material 202 against the flat portion 138. The vacuum corresponding to the vacuum apertures 142 extending from the pockets 140 retains the bands 208 formed from the web of shapable material 202 in the pockets 140.

The plate train 106 may then be advanced so that the plate 134, and hence the bands 208 and bases 206, is conveyed toward the idler roller 110, as shown in block 310. Simultaneously or sequentially, the idler roller 110 may draw the web of substrate material 204 against the bases 206 formed from the web of shapable material 202, as shown in block 312. This may initiate a bond between the bases 206 and the web of substrate material to form backings 210 reinforcing the bases 206.

The plate train 106 may then be advanced so that the plate 134, and hence the bands 208, bases 206, and backings 210, is conveyed toward the compression rollers 112, as shown in block 314. The bands 208, bases 206, and backings 210 may be passed between the compression rollers 112, thereby compressing the bases 206 and backings 210 together and enhancing the bond therebetween, as shown in block 316.

The above steps may be performed repeatedly and simultaneously with the web of shapable material 202 and the web of substrate material 204 being advanced through the system 100 so that multiple sets of handles 200 are being formed in different stages via different plates 134 of the plate train 106. For example, one set of handles 200 may be compressed by the compression rollers 112 while subsequent set of handles 200 are being bonded together and the bands of a further subsequent set of handles 200 are being pressed.

The above-described system 100 provides several advantages. For example, the system 100 provides high speed and high volume output by combining conveyor mechanics with roller press mechanics such that sets of eight or more handles may be completed at once and thirty-two or more handles may be in production at any given time. In one embodiment, with each plate 134 having ten pockets 140, ten handles are completed at once, and forty handles being in production at any given time. The vacuum apertures 142 retain the bands 208 in the pockets 140 and retain the bases 206 against the flat portion 138 of the plate to retain the shape and dimensions of the bands 208 and to keep the bases 206 flat. The roller press 108, the idler roller 110, and the compression rollers 112 are adjustable for achieving desired pressures. Furthermore, at least one of the intermediate portions 148 of the discs 146 between the protrusions 150, and the spaces between the discs, allow the adhesive to pass under the roller press 108 without being disturbed.

### ADDITIONAL CONSIDERATIONS

The detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The detailed description is, therefore, not to be taken in a limiting sense. The scope of the current invention is defined only by the appended claims, along with the full scope of equivalents to which such claims are entitled.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A system for pressforming handles each having a base and a band via a web of shapable material and a web of substrate material, the system comprising:
a carriage;
a conveyor assembly mounted on the carriage, the convey assembly including:
a first sprocket configured to rotate relative to the carriage;
a second sprocket spaced from the first sprocket and configured to rotate relative to the carriage; and
a roller chain linking the first sprocket and the second sprocket;
a plate train conveyably engaged with the roller chain, the plate train including a plurality of plates, each plate including:
a flat portion; and
a plurality of pockets spaced from each other via the flat portion; and
a roller press configured to rotate relative to the carriage and engage the web of shapable material opposite the plates of the plate train, the roller press including a plurality of protrusions annularly and longitudinally spaced apart from each other and configured to press the shapable material into the pockets of the plates thereby forming the bands.

2. The system of claim 1, further comprising an idler roller configured to initiate bonding between the shapable material and the substrate material via the adhesive thereby forming the bases.

3. The system of claim 1, further comprising a compression roller spaced from the idler roller and configured to compress the shapable material and the substrate material together to increase bond strength therebetween.

4. The system of claim 1, each plate further including a vacuum hole extending from each pocket and configured to retain the shapable material in the pocket.

5. The system of claim 1, each plate further including vacuum holes extending from the flat portion and configured to retain the shapable material against the flat portion.

6. The system of claim 1, each plate further including a plurality of pairs of vacuum holes extending from the flat portion and configured to retain the shapable material against the flat portion, each pocket being positioned between one of the plurality of pairs of vacuum holes.

7. The system of claim 1, further comprising a sensor positioned near the plate train for ensuring timely application of adhesive to the web of shapable material relative to the pockets.

8. The system of claim 1, the plates being pivotably linked to each other.

9. The system of claim 1, each plate including a plurality of struts, the roller chain being configured to engage the struts to advance the plate.

10. The system of claim 1, wherein the roller press further includes intermediate portions annularly spaced between the protrusions, the intermediate portions being annularly curved with a constant radius from a rotational axis of the roller press.

11. A method of pressforming handles via a web of shapable material and a web of substrate material, the method comprising steps of:
conveying a plate of a plate train to a pressforming position near a roller press;
feeding the web of shapable material between the plate and the roller press; and
shifting the roller press so that a plurality of protrusions of the roller press extend into a plurality of pockets of the plate thereby forming bands from the shapable material.

12. The method of claim 11, further comprising a step of drawing the web of substrate material against the web of shapable material via an idler roller after the bands are formed thereby bonding the web of substrate material to the web of shapable material.

13. The method of claim 12, further comprising a step of applying adhesive to the web of shapable material before the conveying step.

14. The method of claim 13, further comprising steps of detecting a position of the plate via a sensor and applying the adhesive according to the position of the plate.

15. The method of claim 12, further comprising a step of passing the web of shapable material and the web of substrate material between compression rollers after the drawing step thereby compressing the web of shapable material and the web of substrate material together.

16. The method of claim 11, further comprising a step of retaining the web of shapable material against a flat portion of the plate via vacuum holes extending from the flat portion of the plate.

17. The method of claim 11, further comprising a step of retaining portions of the web of shapable material in the pockets via vacuum holes extending from the pockets.

18. The method of claim 11, further comprising steps of:
conveying an additional plate of the plate train to the pressforming position near the roller press;
feeding the web of shapable material between the additional plate and the roller press; and
shifting the roller press so that an additional plurality of protrusions of the roller press extend into an additional plurality of pockets of the additional plate thereby forming additional bands from the shapable material.

19. The method of claim 18, the shifting step including rotating the roller press.

20. A system for pressforming handles via a web of shapable material and a web of substrate material, the system comprising:
a carriage;
a conveyor assembly mounted on the carriage, the convey assembly including:
a first shaft rotatably supported on the carriage;
a first sprocket attached to the first shaft to rotate therewith;
a second shaft rotatably supported on the carriage and spaced from the first shaft;
a second sprocket attached to the second shaft to rotate therewith; and
a roller chain linking the first sprocket and the second sprocket;
a plate train conveyably engaged with the roller chain, the plate train including a plurality of plates pivotably connected to each other, each plate including:
a flat portion; and
a plurality of pockets spaced from each other via the flat portion;
a roller press configured to engage the web of shapable material opposite the plates of the plate train, the roller press including:
a third shaft rotatably supported on the carriage; and
a plurality of discs attached to the third shaft to rotate therewith, each disc including:
a plurality of intermediate portions annularly spaced apart from each other; and
a plurality of protrusions annularly spaced apart from each other between the intermediate portions and configured to press the shapable material into the pockets of the plates;
a sensor positioned near the plate train for ensuring timely application of adhesive to the web of shapable material relative to the pockets;
an idler roller configured to initiate bonding between the shapable material and the substrate material via the adhesive; and
a compression roller spaced from the idler roller and configured to compress the shapable material and the substrate material to increase bond strength therebetween.
